(19) United States
(12) Patent Application Publication
(10) Pub. No.: US 2003/0028457 A1
(43) Pub. Date: Feb. 6, 2003

(54) Methods and systems for establishing financial goals and predicting success in association with fundraising activities

(76) Inventors: Landon Thomas Costa, Ellwood City, PA (US); Frank Szabo, Ellwood City, PA (US)

Correspondence Address: KIRKPATRICK & LOCKHART LLP, 535 SMITHFIELD STREET, PITTSBURGH, PA, 15222, US

(21) Appl. No.: 10/192,735

(22) Filed: Jul. 9, 2002

Related U.S. Application Data
(60) Provisional application No. 60/303,833, filed on Jul. 9, 2001.

(51) Int. Cl. G06F 17/60

(52) U.S. Cl. 705/35; 705/27

(57) ABSTRACT

Methods and systems are provided for determining a financial expectation of an organization employing a product in association with a fundraising activity. In one embodiment the method includes receiving at least one product variable associated with the product; receiving at least one organization variable associated with the organization; and, generating at least one expected revenue formula related to the fundraising activity based on at least the product variable and the organization variable. In another aspect of the present methods and systems, at least one of the variables includes a predictor variable. In another aspect of the present methods and systems, the generating step further includes employing at least a predictor variable for performing a regression analysis to generate the expected revenue formula. Computer-readable media embodiments and system embodiments are also provided in association with various aspects of the present method embodiments.

### CROSS-REFERENCE TO RELATED APPLICATION

This application claims priority of U.S. provisional patent application Serial No. 60/303,833, filed on Jul. 9, 2001.

### BACKGROUND

### FIELD OF THE INVENTION

The present invention generally relates to methods and systems for goal-setting and establishing predictive models of financial success.

### SUMMARY

Methods and systems are provided for determining a financial expectation of an organization employing a product in association with a fundraising activity. In one embodiment the method includes receiving at least one product variable associated with the product; receiving at least one organization variable associated with the organization; and, generating at least one expected revenue formula related to the fundraising activity based on at least the product variable and the organization variable. In another aspect of the present methods and systems, at least one of the variables includes a predictor variable. In another aspect of the present methods and systems, the generating step further includes employing at least a predictor variable for performing a regression analysis to generate the expected revenue formula.

Computer-readable media embodiments and system embodiments are also provided in association with various aspects of the present method embodiments.

### BRIEF DESCRIPTION OF THE FIGURES

FIGS. 1-A through 1-I include a flowchart illustrating operation of a method and system for predicting results and/or setting goals in association with fundraising;

FIG. 2 is a sample screen display provided in connection with an embodiment of a computer-implemented fundraising method and system;

FIG. 3 is a sample screen display provided in connection with an embodiment of a computer-implemented fundraising method and system;

FIG. 4 is a sample screen display provided in connection with an embodiment of a computer-implemented fundraising method and system;

FIG. 5 is a sample screen display provided in connection with an embodiment of a computer-implemented fundraising method and system;

FIG. 6 is a sample screen display provided in connection with an embodiment of a computer-implemented fundraising method and system; and,

FIG. 7 is a sample screen display provided in connection with an embodiment of a computer-implemented fundraising method and system.

### DETAILED DESCRIPTION

Overview

Methods and systems are provided to guide an organization such as a non-profit organization, for example, through a process that addresses the organization's fundraising ability, among other factors, to identify and present a fundraising program to the organization. These methods and systems are typically practiced in connection with one or more relational databases containing information related to one or more products. In at least one embodiment, these products can be offered for sale and sold by the organization in association with various fundraising activities. As used herein, the terms “product” or “products” include at least one or more of a product, a service, or a reasonable combination of at least one product and at least one service.

The present methods and systems offer the ability to raise funds, with relatively enhanced speed, efficiency, control and manageability. The methods and systems can also reduce the work involved in fundraising and the commensurate need for volunteers, planning sessions, and organizational meetings. The methods and systems also provide an increase in fundraising product choices and associated revenues by centralizing information associated with fundraising activities.

In one system embodiment of the present methods and systems, an online relational database is provided that allows fundraising decision-makers to move interactively from their financial needs to a set of fundraising options. In one aspect, the system presents a user, who can be associated with an organization, with an online survey to identify and inventory the needs of the organization. As the user completes the survey, the system adjusts and adapts the database by adding, deleting, and/or manipulating information. When the user is finished entering relevant organization data, the system can analyze and consolidate the information into a fundraising program. Depending on the nature of the organization's needs as represented by the entered data, processing of the system provides one or more options to the organization in this fundraising program for addressing its needs.

In one aspect, in connection with one or more of the fundraising options, the user can access methods and systems that use text, graphics, audio/video, commercial online services, message boards, e-mail, chat rooms, and other similar functionality to present the user with a body of information related to each fundraising option. It can be appreciated that this aspect provides the user with, among other possible information, the following fundraising information:

1. A text abstract of the option with overview, statistics, names and links to contact/interaction information;

2. Graphics, pictures, audio, and video displays of the products and services associated with the option; and/or,

3. A multimedia presentation explaining the desired fundraising program.

Another aspect of the present methods and systems provides goal-setter functionality. In summary, the goal-setter can set goals for a particular product based on non-specific prior performance associated with that product. Goal-setting can be performed for any product for which a user desires information. Goal-setter can provide estimates of the financial return on a fundraising effort, for example, based on predetermined information obtained from a source such as a product vendor, for example.

Once sufficient information on a product is gathered, the product may be made available for an organization/user to access with predictor functionality. In summary, predictor functionality predicts an organization's financial success based on one or more factors such as organization-specific past performance, for example, associated with a particular product. The predictor therefore draws upon information associated with actual performance of products and services in connection with predicting the success of fundraising activities.

The present methods and systems can apply, in some embodiments, predictor variables that can be considered common “truths” that have the proven ability to predict. Predictor variables are typically variables that have been statistically proven to have an ability to predict or forecast financial success and can be based on collected information related to actual fundraising efforts. Predictor variables are usually stored for use by the present methods and systems in a suitable electronic format. The collected data can undergo statistical analysis (e.g., regressions, correlations, plots, linear fits, and the like) to produce a formula that has the ability to predict outcomes when using a product/vendor for a given fundraising activity.

Director variables can also be used to enable organizations to reach goals through situational game planning. Director variables include organization-specific, product-specific and/or vendor-specific information. Director variables permit situational game planning while applying a specific “cookbook” approach to fundraising efforts. Director variables facilitate the organization reaching goals established through use of predictor variables.

In summary, it can be appreciated that there is a transformation from goal-setter functionality to predictor functionality. In predictor mode, the product/vendor receives a prediction and not merely an estimated result as provided in goal-setter mode. This prediction is based on “trials” associated with actual fundraising activity. The results of these trials are then entered into a database, or another suitable electronic storage means, of the method and system. According to the specific product/vendor and the specific user, the method and system generate an appropriate formula to predict the results of proposed future fundraising activity.

In generating the formula, a number of variables appropriate to the context of the fundraising activity and the organization are applied. A situation can be created wherein it is determined that certain variables have enhanced predicting value as compared to some of the other, remaining variables in the formula. The remaining variables can be classified as director variables that direct the user to one or more options for reaching the goal that the predictor formula has created.

It can be seen that the present methods and systems are dynamic and continuous. Data accuracy generally continues to improve with each trial and the collected data can be checked periodically for new variables with predicting ability and common truths. Prior trials can also be checked for relevance/validity as the present methods and systems build enhanced prediction models. As the method and systems continue to improve, some trial information can be purged if its application is inconsistent with current changes in results due to process efficiency.

In certain embodiments of the present methods and systems, predictor and director variables are typically classified as a result of system analysis. Regression and correlation type analyses can be employed to classify the variables. Data on one or more variables associated with a product are collected by the present methods and systems. A variable that has a statistically proven ability to predict within a significant degree or percentile, such as one that predicts results with at least approximately 90% accuracy, can be classified as a predictor variable. The variables that have comparatively lesser predicting ability typically are not incorporated into formulas for predicting results based on user and product information and can be designated as director variables. Director variables have the ability to develop the organization's/user's specific “cookbook” approach that aids in attaining the predicted outcome provided by the method and system has determined. Therefore, a predictor variable maintains the ability to predict fundraising results, within a certain degree of confidence, when used in formula construction. A director variable maintains the ability to support the predicted result of the method and system and can be used as a means to determine proper scripts, suggestions, safety tips, and the like.

With regard to construction of a formula for predicting results, correlation and regression type statistical analyses can be performed, in one embodiment of the present methods and systems, on products and user groups. As information is collected on variables, statistical research can be performed that analyzes each variable's relationship and/or impact on a predicted result. This analysis determines the classification of the variable into either the director category or the predictor category. Once the predictor status variables have achieved a significant number of trials with a satisfactory degree of accuracy, these predictor variables can provide the source data for formula creation. They have become “truths” for purposes of fundraising, for example, of certain products in various situations. For these formulas, the predictor variable values are determined by their fit in relationship to the product. It can be seen that, as part of the statistical analysis, the coefficients in the formulas are related to the information derived from a specific user/organization. The method and system can therefore create predicted results, through use of a formula, according to a chosen product and the organization's specific information. This formula and its results can then be executed in connection with the above-discussed director variables.

The present fundraising methods and systems can be embodied on a network, which can be an internal, networked computer system or a global networked communications medium such as the Internet, for example, operatively connected through a connection to a computer. The fundraising methods and systems can be embodied, for example, as a set of instructions included on a computer-readable medium executed by an operating system and stored in data storage of a computer. The computer-readable medium can include hard disk storage, diskette, CD-ROM, the data transfer medium between the network and the computer, or another functionally equivalent computer-readable medium.

In one aspect of the present methods and systems, a user can access at least a portion of the fundraising system by using the computer to obtain and execute a computer program from the network, and/or from the data storage, that performs the steps of the methods described herein. It can be appreciated that the computer can be replaced by a client-server arrangement, a wireless device such as a personal digital assistant (PDA), or another electronic device suitable for executing the fundraising system. In addition, it can be understood that instructions for performing the present methods and systems can be executed on a stand-alone basis without a network connection. The fundraising system can be implemented, for example, as a series of graphical user interfaces on a personal computer with conventional windows, drop-down menus, and/or similarly functionally equivalent features.

### EXAMPLES

The following examples are intended to provide potential embodiments of the methods and systems discussed herein. It can be appreciated that these examples are provided for purposes of illustration and to demonstrate practice of the present methods and systems for those skilled in the art. No particular aspect or aspects of these examples are intended to limit the scope of the invention. Choice of a particular nomenclature, variable representation, or other illustrative aspect is intended merely for convenience of disclosure to illustrate a potential embodiment of the methods and systems discussed herein.

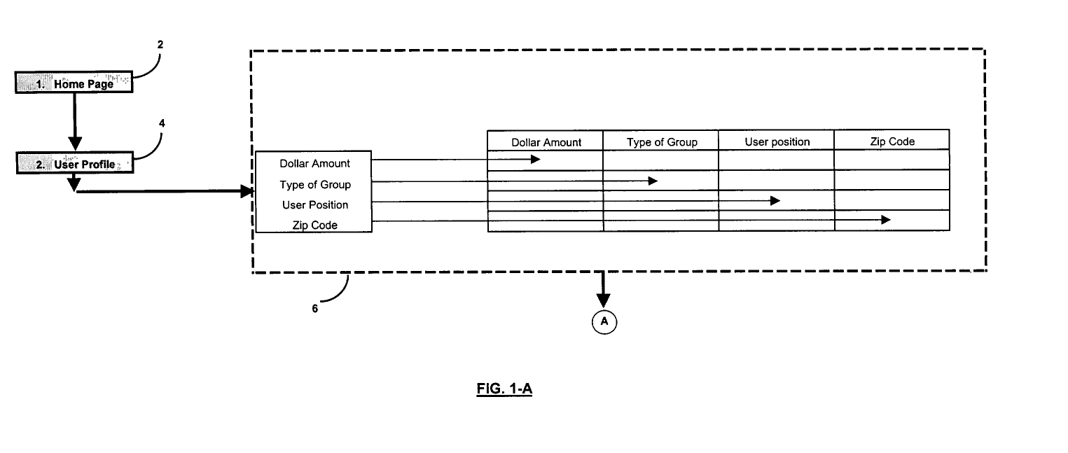

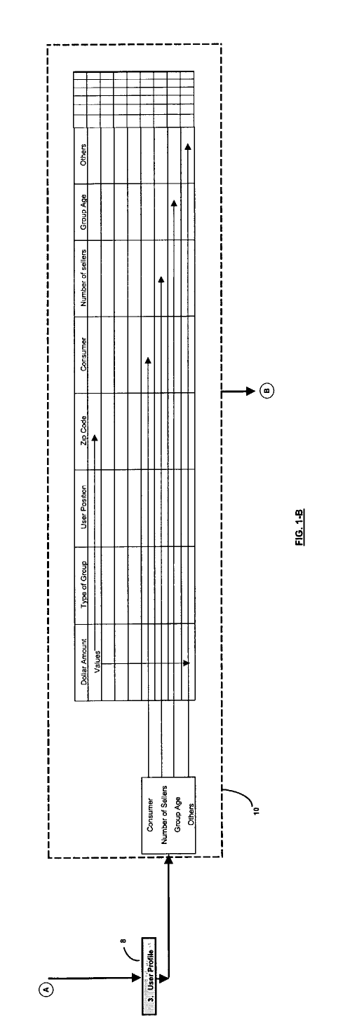

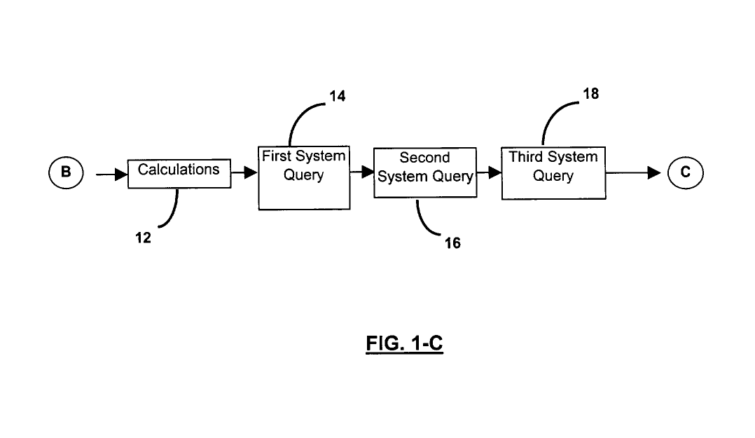

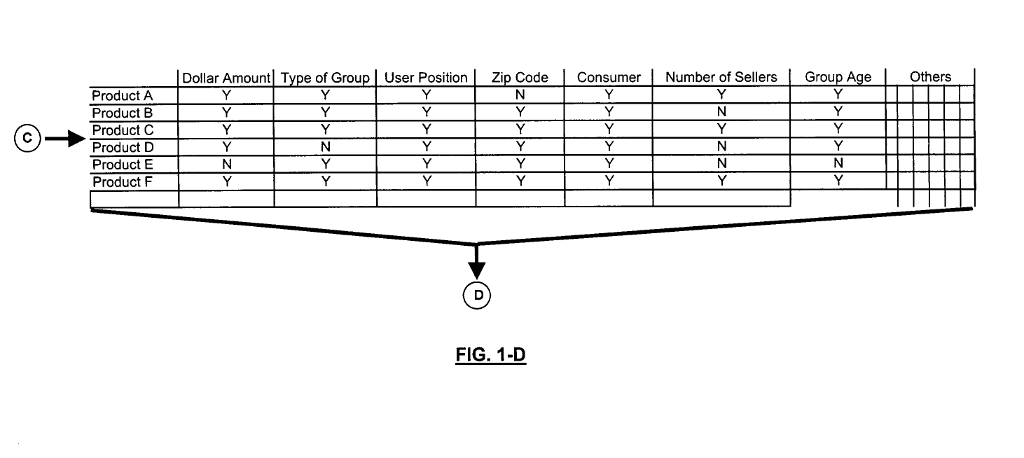

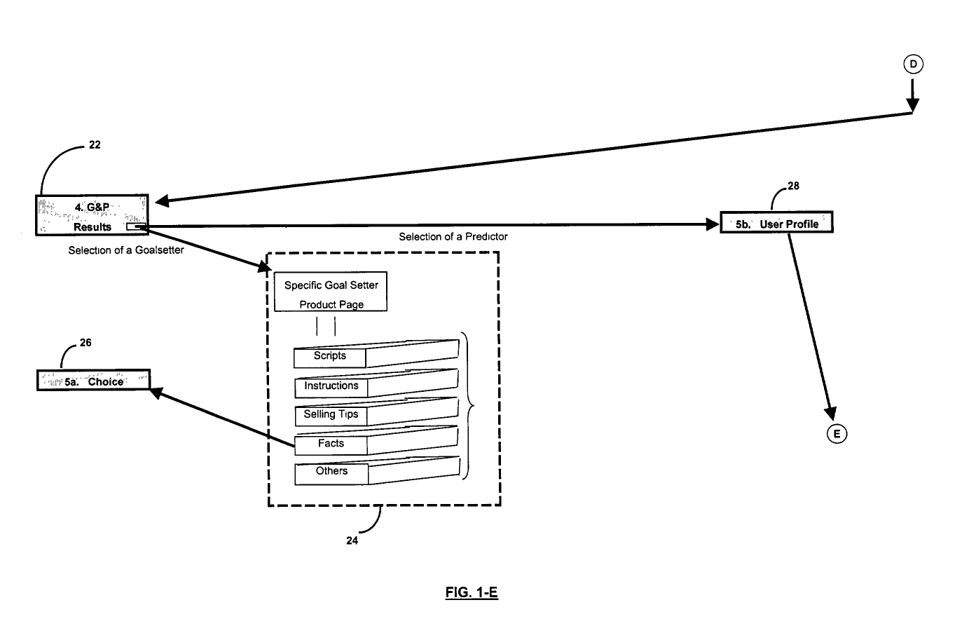

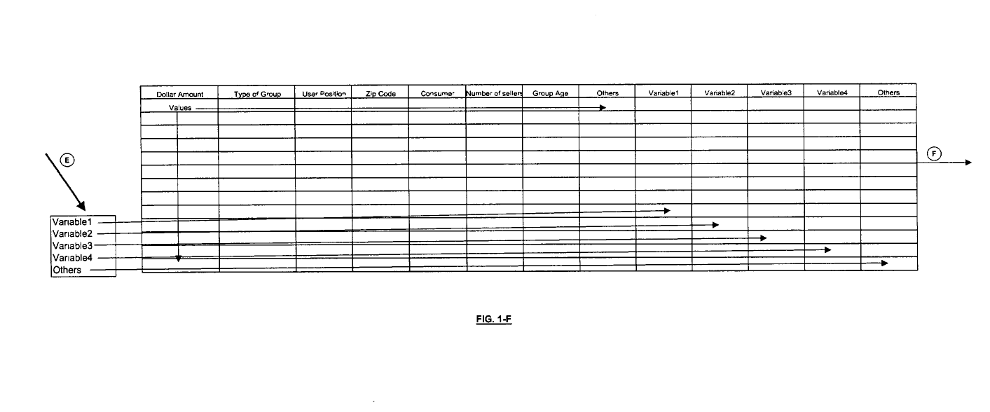

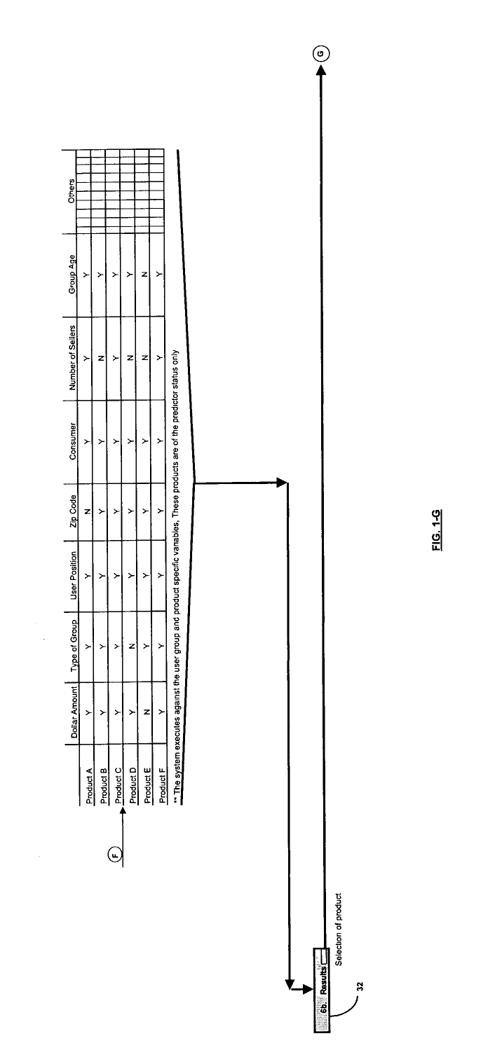

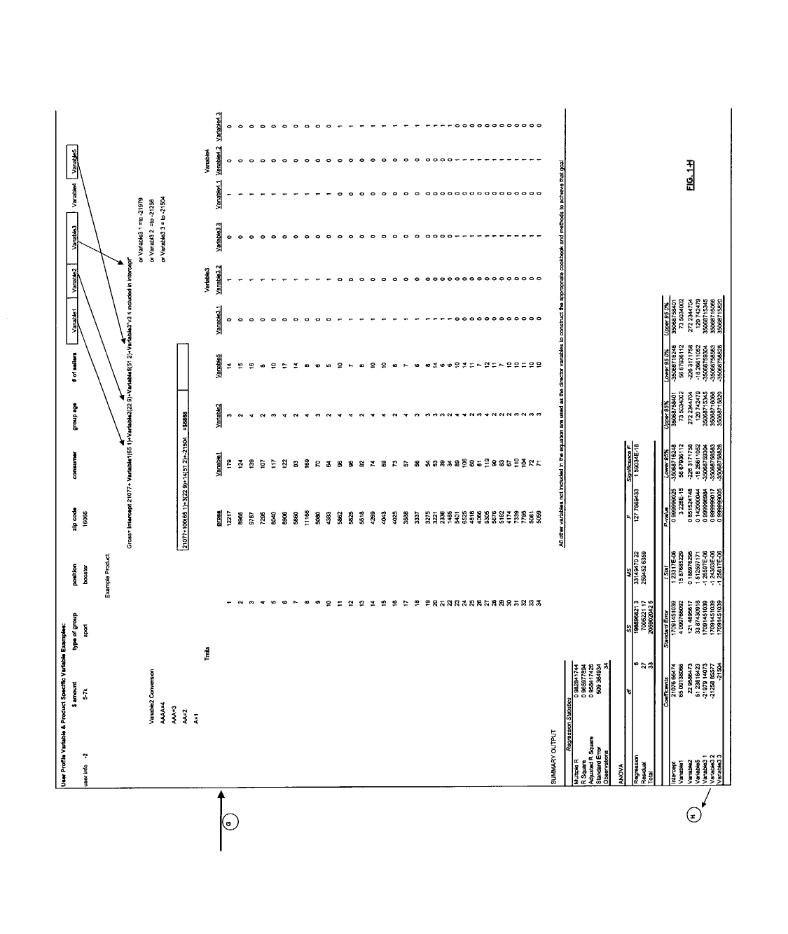

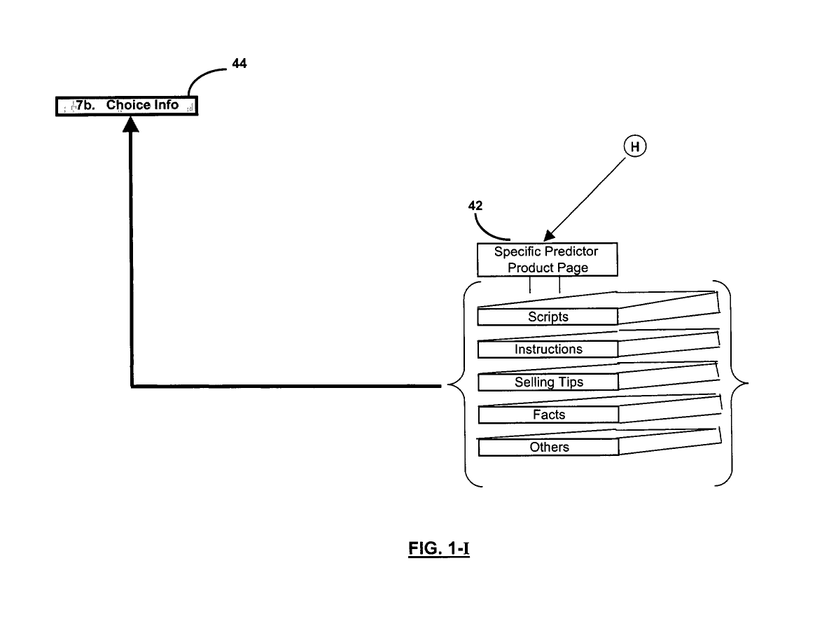

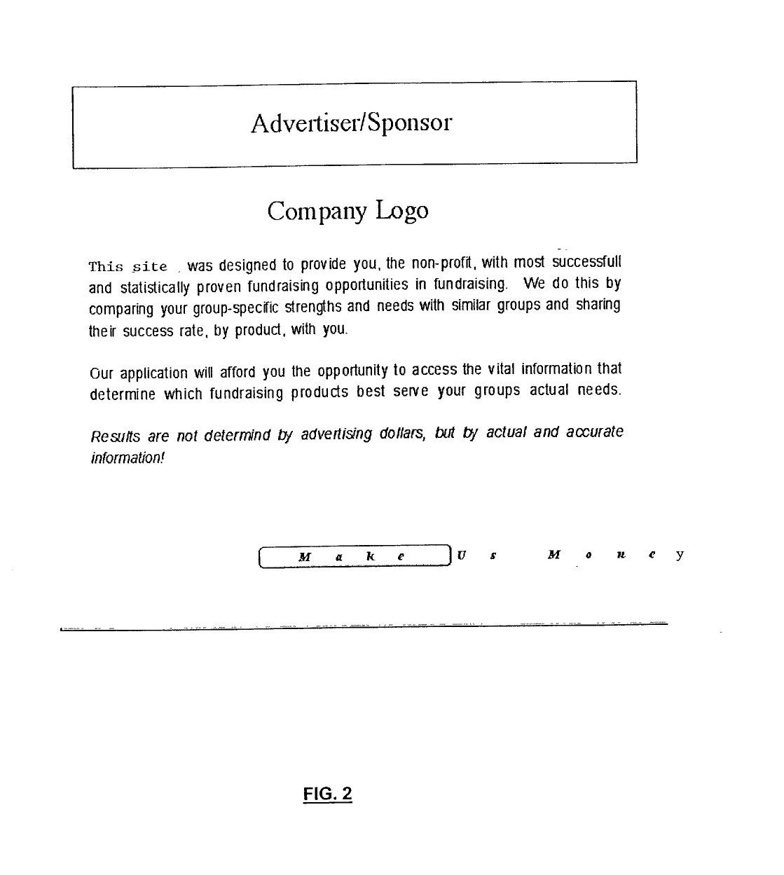

Referring now to the flowchart presented in FIGS. 1-A through 1-I, in connection with FIGS. 2 through 7, an illustrative embodiment of a fundraising method and system consistent with the above discussion is provided.

As shown in FIG. 1-A, the fundraising method can begin by providing a home page 2 in the form of an Internet site for a user to access. FIG. 2 provides an illustrative screen display in accordance with this home page. Basic information about a company offering the present methods and systems appears on this home page 2. It can also contain one or more of the following pieces of information:

1. Company logo

2. Introduction

3. Predictor and Goal-setter explanations

4. Marketing Opportunities

5. Account Access

6. Contact Information—phone number, e-mail address, etc.

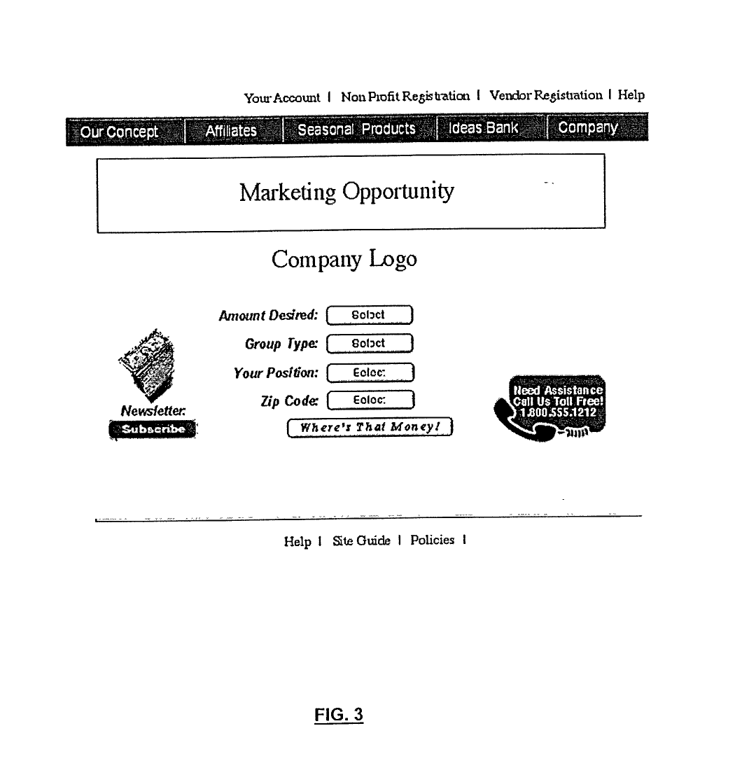

Referring again to FIG. 1-A, a user profile can be entered in a first user profile page 4. This profile page 4 can be provided as a screen display as shown in FIG. 3.

As shown in section 6, the user profile page 4 begins to build a profile of the specific user and the associated organization, from pull down menus or another suitable functionality, with the following illustrative variables:

Dollar Amount:

$100-500

$501-$1,000

$1,001-$2,500

$2,501-$5,000

$5,001+

Group Type:

Schools

preschool

primary

secondary

post secondary

Youth Organizations

baseball

football

basketball

hockey

other sports

Y Teens

Young Miss

Jr. Achievement

Boy Scouts

Cub Scouts

Brownies

clubs

camps

other

Churches

adults group

youth group

bible camp

missions

other

Social Clubs

Elks

Lions

Wolves

Vets

Kiwainia's

Masons

Oddfellows

Cubs ASA

YMCA

YWCA

Young Women

Jaycees

military

other

Public Interest

Special Olympics

Big Brothers/Sisters

Association for Retarded Citizens

Association for the Blind

youth home

rescue mission

food bank

Meals on Wheels

shelter

Habitat for Humanity

Humane Society

environmental

AARP

MADD

other

Health

Cancer Society

Heart Association

Diabetes

Epilepsy Foundation

Aids Awareness

mental health

alcoholism

other

Public Safety

police

fire

paramedics

rescue

recovery

other

User Position:

Member

Parent

Student

Teacher

Sponsor

Zip Code of Organization

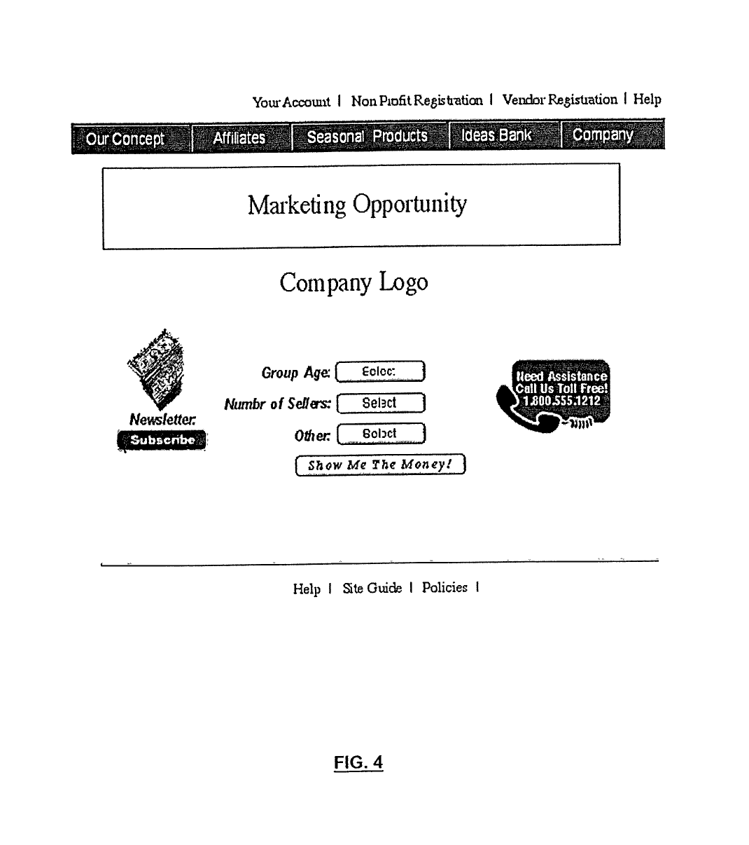

Referring now to FIG. 1-B and its associated FIG. 4, the user can continue to build a profile of the specific user and the associated organization, in component/step 8 as follows:

Consumer:

Within the group (Within School)

Family/Relatives

Door to Door (General Public)

Group Age:

Pre Teenager

Teenager

Adult

Number of Sellers:

1-20

21-50

51+

Referring again to FIG. 1-B and FIG. 4, the additional information entered by the user as part of the user profile as shown in section 10 is stored in a database upon clicking a button or its functional equivalent.

Referring now to FIG. 1-C, the method and system can calculate profits for each of the vendors' products that are included in the method and system in step 12. Product profit calculations can be provided by the following calculation: (number of students×products per student calculation)+(number of adults×products per adult calculation).

This profit calculation is then forwarded to the first system query in step/component 14 which compares the calculated figure against the database. The first query 14 establishes a link to products in the system that match the specified number of sellers criterion. In the first system query 14, the system selects substantially all products in which the total number of sellers falls within the low and high seller limit associated with the organization. At least one month selected (start/finish) is in that product's month data. It can be appreciated that any product can potentially require a different calculation based on how many sellers will be selling that product. For each product stored in the database, the seller range (e.g., 1-20, 21-50, 50+) is stored for that specific calculation. Also, the present method and system can associate each product calculation with a month or months of the year for which the calculation is valid and/or can be optimally used.

It can be understood that some products frequently produce better results during some months than others. These seasonal fluctuations can be tracked and a new calculation can be stored, by month, to produce more accurate results for a predictive formula. The first system query 14 takes the “Number of Sellers” entry selected by the user and the time of the year (i.e., start time and finish time). The method and system then collect products from the database that include the seller range (low and high seller limit) and at least one of the months from the user's start/finish period selection.

Those matched products are then processed by a second system query in step/component 16. In this query, the products matching the first system query are referenced for desired time periods for sale of the products. These time periods can be embodied in terms of desired months as well as a general desired time frame. In the second system query 16, the result of the first system query that is selected for the duration of the selling period is applied by the method and system. This query 16 produces a subset of product records and another calculation is performed on each product record using the selections made by the user through the method and system.

The products matching the time period criterion are processed by a third system query in step/component 18. This determines the profit/month of each of the matching products. A list matching the user profile can be displayed that lists, among other items, the products, categories and profit information for a given fundraising option. In a third system query 18, the method and system use the results of the second system query 16, in which the like products in each product category are provided and each individual month's profit is added. All matching product records in each product category are grouped together. Next, the calculated profit for each month of the selected start/finish period for the organization/user is added to provide a total estimated profit for each product in a format ready for presentation to the user.

These results are then sorted in descending profit amount order, for example, or another sort order convenient for presentation to the user. Any product dollar amount equal to or greater than the user's entered dollar amount is compiled and prepared for display to the user. If the processing for a product stops here, the product is only of goal-setter status. The goal-setter functionality can provide realistic goals for the organization/user, while the information on each of the trials is collected and researched to take, if possible, the goal-setter product to the predictor level.

If sufficient data is available to continue, as discussed further hereinbelow, the product can also maintain predictor status. Sufficient data refers to the system having enough information to statistically analyze and classify product variables as predictor variables or director variables. The ability to do this is a direct result of building the number of user trials, so that there is enough information to provide a formula with a relatively high level of confidence and/or accuracy. When a predefined number of users have accessed/processed a product on the system, the formula for that product can evolve with each additional trial associated with actual fundraising experience. Once the variables of the predictor status have reached a significant number of trials and a satisfactory degree of accuracy, these predictor variables can create a predictive formula. They have become the “truths” for the products in various situations.

A display of products presented to the user is shown in FIG. 1-D. FIG. 1-D displays how the values determined by the system queries and calculations discussed above are used to match the organization/user with the products contained in the system. Through this process, the appropriate products (i.e., the products containing corresponding values to the multiple variable database information) can be selected.

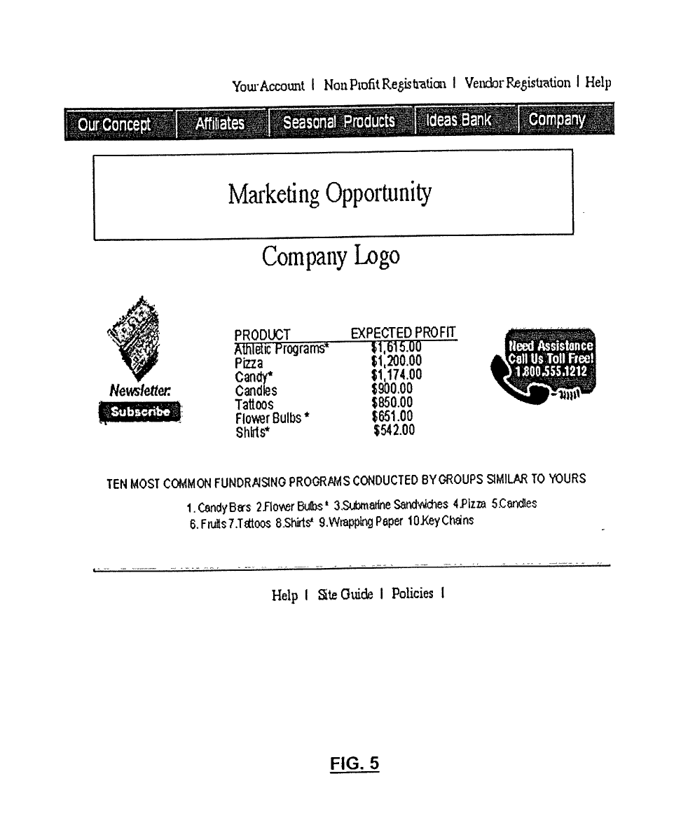

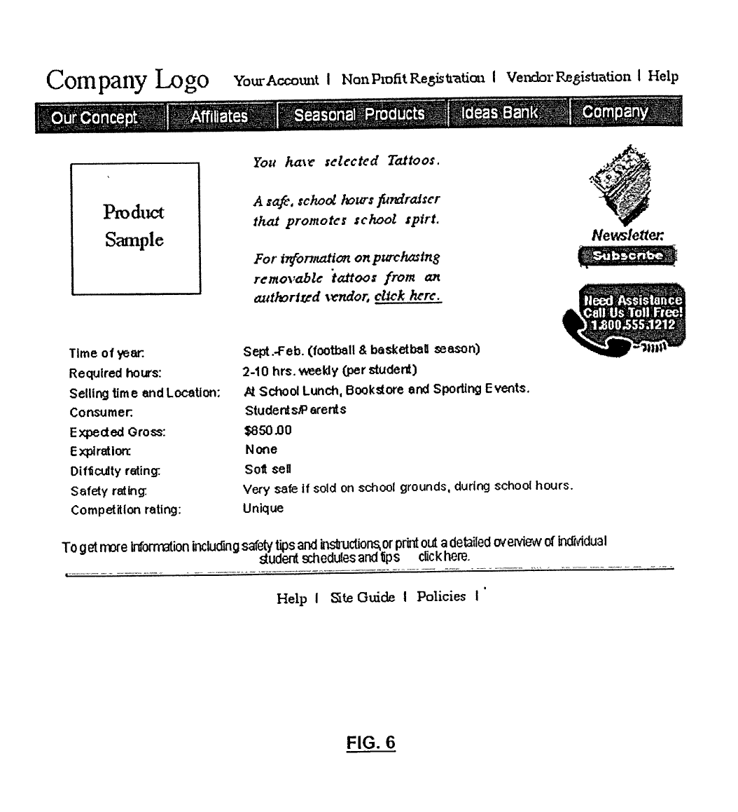

Referring now to FIGS. 1-E and FIGS. 5 and 6, results of goal-setter and predictor status products are displayed in step/component 22, wherein the above method and system operations determine either matching goal-setter products or matching products/vendors. The user can make a selection among the goal-setter and/or predictor status products that are presented in step/component 22. In the case of a goal-setter product, the lack of sufficient data for predictor status results in the user being guided to a specific goal-setter product page 24 and the appropriate solutions are provided for that product/vendor in step/component 26. If the user selects a vendor/product with sufficient data to warrant predictor status, then the user can proceed to step/component 28.

With specific regard to step/component 22 and FIG. 5, the method and system provide results based on the organization's profile. The results may apply to products with goal-setter and/or predictor status. When the results apply to one or more predictor status products, such products can be noted as such (i.e., marked with an asterisk (“*”) in FIG. 5). The results page can also include a Top Ten List that offers non-profit groups the ten most common fundraising programs that are conducted by similar organizations. This Top Ten List can be generated based on the selections the user made during the above-discussed profiling activity.

An example of results associated with FIG. 5 is shown as follows:

| PRODUCT | EXPECTED PROFIT |
|---|---|
| Athletic Programs* | $1,615.00 |
| Pizza | $1,200.00 |
| Candy* | $1,174.00 |
| Candles | $900.00 |
| Tattoos | $850.00 |
| Flower Bulbs* | $651.00 |
| Shirts* | $542.00 |

(*Denotes a product for which predictor status is applicable.)

The results generated by the above processing can be displayed on a web page to the user in a linked, hypertext fashion. This allows a specific product selection by the user from the results that have been provided.

If the user selects a product in goal-setter, such as pizza (as in the above example), the user is sent to the page in step/component 26 for further review of fundraising options. As discussed above, the goal-setter functionality relies on systems queries and average sales results for products (potentially obtained from a vendor or vendors for those products) to provide estimated results. When product selection occurs, the system routes the selection for appropriate processing. If a goal-setter product is chosen it prompts the specific goal-setter product page. If sufficient data needed to predict a result has not been established, the system treats the variables as director variables and queries information contained in component/step 24 to create the fundraising package to complement that specific product selection and user profile. When a product of predictor status is selected, the method and system proceed to obtain additional user profiling information. This information is then sent from the steps/components shown in FIG. 1-E to the steps/components shown in FIG. 1-F.

In comparison, as discussed above, as usage of a product for fundraising activities continues, the number of experimental trials for that product increases. These trials provide actual data to the method and system to achieve a data level sufficient for application of predictor status. Sufficient data may be considered to have been achieved upon a predetermined number of actual trials, such as 30 to 40 trials, for example, of specific products. It can be appreciated that the number of trials necessary for predictor status to apply may depend on a plurality of factors including detection of common truths, variable productivity, and other factors.

Referring again to step/components 24 and 26 in FIG. 1-E, these pages offer information on the product selected by the organization for fundraising activities. This information can include one or more of the following illustrative categories: time of year to sell product, required hours, the consumer difficulty rating, the safety rating, and/or the competition rating. Examples of ratings are described as follows:

Safety Ratings—Pre-determined in accordance to the product and the consumer.

Competition Ratings—Determined by the frequency the product is sold as a fundraiser. This may require account information on the fundraising activities of other organizations.

Consumer Difficulty—Determined by degree of access the organization possesses with the prospective consumer.

This page can also offer director variables, safety information, instructions, selling tips, and the like, as well as one or more links to one or more vendors offering the products in the method and system.

In step/component 26, the present method and system pull from both the director and predictor variables that have been submitted by the user for the specific product that has been chosen. The system then sends the information that corresponds to the needs of the user to step/component 26 and the screen display shown in FIG. 6.

A fundraising package or program is put together by the system, according to a variable/non-variable selection process, in conjunction with a linear fit of information. The database can also pull documentation including the following: goals, instructions, safety tips, selling tips, suggestions, incentive programs, facts, sample scripts, self-assessment sales ability forms, and the like. The fundraising package can include a checklist to assist the organization in every aspect of the fundraising scope, from time management to actual sales presentations, for example. The method and system also offer links to other Internet sites providing safety instructions. In addition, instructions within the system can be presented to the organization/user through paid sponsorships (e.g., MADD).

In one example of operation of the present fundraising method and system, based on 32 trials associated with actual fundraising performance of athletic programs, a fundraising analysis produced the following predictor formula:

Gross=intercept 54271.8+number of ads (65.7)+school size (15.8)+number weeks (53.3)+season spring included in the intercept

Or Winter=55211

Or Summer=54549

Or Fall =54784

Next, a formula is generated based on the following profile of an athletic program type of organization:

Profile:

School name: Aliquippa

Group name: Football

Zip code: 15001

Position of user: Booster

Dollar amount desired: $4,000

Number of sellers: 6

Number of ads: 60

School site: AA (Double A)

Selling season: summer

Weeks selling: 5

Predicted=54271+60(65.7)+2(15.8)+5(53.3)+−54549=$3,966

Actual Information from Trial:

Dollar amount: $4,383

Number of sellers: 7

Number of ads: 64

Weeks selling: 5

This actual trial information can then be fed back into the method and system for generation of a further prediction formula. In this example, now based on 33 trials, statistical analysis by the method and system produces a formula for a subsequent fundraising effort:

Gross=intercept−589+75(65.4)+3(15.9)+11 (50.7)+season

Spring included in intercept, or

Winter=−311, or

Summer=389, or

Fall=128

Next, the following organization applies the present methods and systems pursuant to the following profile:

Profile:

School name: Valley

Group type: Basketball

Zip code: 15068

Position of user: Coach

Dollar amount desired: 5-6 thousand

Number of sellers: 8

Number of ads: 75

School site: AAA (Triple A)

Selling season: Fall

Weeks selling: 11

Predicted=−589+75(65.4)+3(15.9)+11 (50.7)+128=$5,049.70

Actual Information from Trials:

Dollar amount: $5,059

Number of sellers:8

Number of ads: 71

Weeks selling: 10

The actual trial information is fed back into the method and system and suitable statistical analyses are executed. Now based on 34 trials, the method and system provide a statistical analysis that produces another formula for predicting subsequent fundraising activity:

Gross=intercept 21077+number of ads(65.1)+school site(22.9)+number of weeks selling(51.2)+season

Spring included in intercept, or

Or Winter=−21979, or

Or Summer=−21258, or

Or Fall=−21504

Referring again to FIG. 1-E, if the product selected by the user has predictor status, the user can select a product that applies to predictor, such as athletic programs, and the user is provided with step/component 28 of FIG. 1-E. The following is a trial example associated with an athletic program type organization as applied to predictor mode:

User/Organization Information:

Dollar amount—5-7 thousand

Position of user—booster

Group type—sports

Zip code—16066

Number of sellers—10

Group age—15-18

Consumer—businesses

Time frame—14 weeks

Sport—basketball

School size—3A (triple A)

Number of ads—100 approximately

The page associated with step/component 28 can ask the user organization-specific and/or product-specific questions that are dependent upon the products selected in step/component 22. As shown in FIGS. 1-F and 1-G, the method and system apply variables, listed as “Variablel” through “Variable4”, to generate a predictor formula. It can be seen how the database values from FIGS. 1-B through 1-D are processed through the method and system, so that the new variables from the user profile in step/component 28 can be added to the compilation. Upon the addition of information in FIG. 1-F, the system performs functions similar to that described for FIG. 1-D. The results sent to step/component 32 are results for which the system has the ability to calculate a prediction by way of a formula with a confidence level corresponding to a number of trials of each product.

Referring again to FIG. 1-G, the present method and system provide results based on the information specific to a product and/or organization in step/component 32. The page associated with FIG. 1-G can include a “winners” list that shows the most financially successful fundraising programs previously conducted by specific organizations and organization types. An example of results provided by step/component 32 in FIG. 1-G is shown as follows:

| PRODUCT | EXPECTED PROFIT |
|---|---|
| Athletic Programs | $1,615.00 |
| Candy | $1,174.00 |
| Flower Bulbs | $651.00 |
| Shirts | $542.00 |

Once a product is selected in step/component 32, the method and system can continue processing as shown in FIGS. 1-H and 1-I. Selection of a particular product generates a specific predictor product page 42 that contains information analogous to step/component 24 discussed above. FIG. 1-H demonstrates that, upon the product selection, the system knows the product's predictor and director variables through the statistical research performed on the trials as listed. In the FIG. 1-H example, variables 1,2,3 and 5 are predictor variables that can be plugged into the formula along with the coefficients to determine a predictive result. The summary output seen in FIG. 1-H shows how the system uses regression statistics to determine the variables to be included in the formula for the trial. The system generates the predicted result and then sends the remaining variables to be processed/grouped with the existing director variables to the steps/components of FIGS. 1-I.

The page associated with the specific predictor product page 42 offers specific information on the product selected by the user/organization. A results page for the predictor functionality can be provided in step/component 44. This results page is consistent with the above discussion of presentation of results to the user/organization. In FIGS. 1-I, the present method and system perform functions substantially equivalent to those performed in step/component 24 of FIG. 1-E as previously discussed.

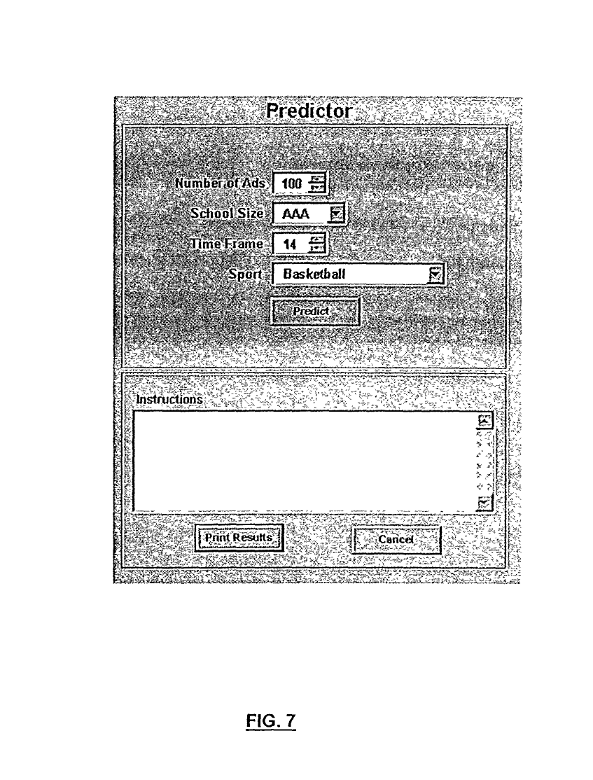

In addition, the screen display of FIG. 7 demonstrates an online tool for use by the user/organization to predict the results of a fundraising activity. With the values entered as shown, the user can click the “Predict” button, and the method and system perform calculations to display the predicted gross amount for the proposed fundraising activity.

It can be appreciated that certain conventional functionality can be added to one or more aspects of the present fundraising methods and/or systems. Common links, for example, that can be added to the web pages discussed herein, include the following: affiliates—non-profit organizations, vendors and support organizations partnered with the company providing the present method and system; seasonal/holiday products—fall, winter, spring, summer, Christmas, Easter, and the like; ideas bank—fundraising ideas and results from other organizations; company—corporate structure, investor relations, member biographies, and the like; Your Account—established organization and vendor point of entrance; registration—opportunity for organizations and vendors to register. Other possible links include the following: Employment Opportunities, Help, Subscribe to Company's Fundraising Newsletter, Phone Number, Policies (for site use), Promotions, Site Guide, and Webmaster.

Whereas particular embodiments of the invention have been described herein for the purpose of illustrating the invention and not for the purpose of limiting the same, it can be appreciated by those of ordinary skill in the art that numerous variations of the details, materials and arrangement of parts may be made within the principle and scope of the invention without departing from the invention as described in the appended claim.

It can be appreciated that the methods and systems disclosed herein are susceptible to continual upgrade with regard to usability and predictability arrangements and methods that help organizations, including non-profit organizations, achieve their goals and inevitably enhance the quality of the organization.

What is claimed is:

1. A computer-implemented method for determining a financial expectation of an organization employing a product in association with a fundraising activity, said method comprising:
receiving at least one product variable associated with said product;
receiving at least one organization variable associated with said organization; and,
generating at least one expected revenue formula related to said fundraising activity based on at least said product variable and said organization variable.

2. The method of claim 1, wherein at least one of said variables includes a predictor variable.

3. The method of claim 2, wherein said generating step further includes employing at least said predictor variable for performing a regression analysis for said generating of said at least one expected revenue formula.

4. The method of claim 1, wherein at least one of said variables includes a director variable.

5. The method of claim 1, wherein at least one of said variables is based on prior financial performance related to said variable in association with a prior fundraising activity.

6. The method of claim 5, wherein said variable based on prior financial performance includes an associated product-specific prior financial performance.

7. The method of claim 5, wherein said variable based on prior financial performance includes an associated organization-specific prior financial performance.

8. A computer-readable medium including instructions for directing a computer to perform a method for determining a financial expectation of an organization employing a product in association with a fundraising activity, said method comprising:
receiving at least one product variable associated with said product;
receiving at least one organization variable associated with said organization; and,
generating at least one expected revenue formula related to said fundraising activity based on at least said product variable and said organization variable.

9. The medium of claim 8, wherein at least one of said variables includes a predictor variable.

10. The medium of claim 9, wherein said generating step further includes employing at least said predictor variable for performing a regression analysis for said generating of said at least one expected revenue formula.

11. The medium of claim 8, wherein at least one of said variables includes a director variable.

12. The medium of claim 8, wherein at least one of said variables is based on prior financial performance related to said variable in association with a prior fundraising activity.

13. The medium of claim 12, wherein said variable based on prior financial performance includes an associated product-specific prior financial performance.

14. The medium of claim 12, wherein said variable based on prior financial performance includes an associated organization-specific prior financial performance.

15. A system for determining a financial expectation of an organization employing a product in association with a fundraising activity, said system comprising:
means for receiving at least one product variable associated with said product;
means for receiving at least one organization variable associated with said organization; and,
means for generating at least one expected revenue formula related to said fundraising activity based on at least said product variable and said organization variable.

16. The system of claim 15, wherein at least one of said variables includes a predictor variable.

17. The system of claim 16, wherein said generating means further includes means for employing at least said predictor variable for performing a regression analysis in said generating means for generating said expected revenue formula.
